(19) United States
(12) Patent Application Publication
(10) Pub. No.: US 2006/0213620 A1
(43) Pub. Date: Sep. 28, 2006

(54) Label affixing machine having label roll core holding mechanism

(75) Inventor: Koichi Shimosaka, Tokyo (JP)

Correspondence Address: OSTROLENK FABER GERB & SOFFEN, 1180 AVENUE OF THE AMERICAS, NEW YORK, NY, 100368403, US

(73) Assignee: Kabushiki Kaisha Sato

(21) Appl. No.: 11/375,482

(22) Filed: Mar. 14, 2006

Related U.S. Application Data
(60) Provisional application No. 60/664,288, filed on Mar. 22, 2005.

(51) Int. Cl. B65H 37/00; B65C 9/18; B44C 7/00

(52) U.S. Cl. 156/540; 156/541; 156/577; 156/DIG. 24; 156/DIG. 33

(57) ABSTRACT

A label affixing machine having a core holding mechanism in which the core holding mechanism is provided in a label-protecting cover body provided openably about a main body housing of the label affixing machine. By rotating the label-protecting cover body, a label roll held by the core holding mechanism can be accommodated within the main body housing of the label affixing machine, a label core support shaft is operable to emerge from and descending into the main body housing in accordance with opening and closing operations of the label-protecting cover body. A fall preventing member slidably supports a side face of the label roll on the core holding mechanism.

### CROSS REFERENCE TO RELATED APPLICATION

This application claims the benefit of U.S. Provisional Application No. 60/664,288, filed Mar. 22, 2005, the entire disclosure of which is incorporated by reference herein.

### BACKGROUND OF THE INVENTION

1. Field of the Invention

The present invention relates to a label affixing machine having a label roll core holding mechanism for holding a label roll, and more particularly to a label affixing machine having a label roll core holding mechanism which is capable of holding a label roll used in a label affixing machine such as a hand labeler in a main body housing of the label affixing machine, wherein the label roll is mounted in a label-protecting cover body, which is attached operable to the main body housing, such that the label roll can be held in the protective cover body by opening and closing the protective cover body.

2. Description of the Related Art

In a conventional label affixing machine, a continuous label strip is fed onto a conveyance path from a supply portion in a main body housing of the label affixing machine and conveyed at a predetermined pitch. A price or other predetermined information is printed (stamped) on the individual label as needed, whereupon the label is peeled away from a backing sheet so that the label can be affixed to a predetermined article or the like.

During printing and conveyance of the continuous label strip, the continuous label strip and backing sheet are usually engaged with a rotatable conveyance wheel in the main body housing of the label affixing machine. When an operating lever is manipulated, a printing portion supported by one end of the operating lever performs a reciprocating motion in the direction of the continuous label strip, and by rotating and stopping the conveyance wheel according to the label pitch, the continuous label strip is conveyed sequentially in a downstream direction. The backing sheet alone is then turned back by a deflection pin or the like such that the label, which advances forward, peels away from the backing sheet.

The continuous label strip is typically held in rolled form (to be referred to hereafter as a label roll) by a core holding mechanism, which serves as the aforementioned supply portion. During an operation to mount the label roll in the label affixing machine, the continuous label strip that is fed from the label roll must be inserted into the main body housing of the label affixing machine and engaged with the conveyance wheel before mounting the label roll, and hence the core holding mechanism of a conventional label affixing machine is inconvenient in terms of the operation required to insert the continuous label strip.

For example, Japanese Examined Patent Application H1-56976 discloses a core holding mechanism in which the label roll is sandwiched between a pair of elastic pieces. The core holding mechanism comprises a holding portion for holding the pair of elastic pieces and the label roll, and is constituted such that the pair of elastic pieces can be engaged with a main body case (main body housing hereafter) of the label affixing machine. In this constitution, the pair of elastic pieces can be stretched outward away from each other, and hence label roll fitting and removal operations are performed with ease. With this constitution, however, the pair of elastic pieces are stretched outward away from each other every time a label roll is mounted, and therefore the space between the elastic pieces may widen as a result of repeated label roll mounting and changing, leading to a problem whereby the core of the label roll can no longer be held between the elastic pieces. Further, since the label roll is sandwiched between the elastic pieces, the length of the elastic pieces must be no less than the radius of the label roll from the core thereof, and depending on the diameter and size of the label roll, the elastic piece holding portion must be provided such that the core of the label roll can be disposed in an upwardly-removed position from the main body housing of the label affixing machine. As a result, the size of the label affixing machine itself increases. Moreover, the pair of elastic pieces are engaged with the main body housing of the label affixing machine such that the pair of elastic pieces are disposed in fixed positions with respect to the main body housing and in the vicinity of the printing mechanism. Thus, if the continuous label strip is fed from the label roll and inserted into the main body housing while the label roll is sandwiched between the elastic pieces as shown in the drawings, it is impossible to secure the space required to perform the insertion operation due to the positional relationship between the wound diameter of the label roll and the main body housing, and hence the continuous label strip cannot be inserted into the main body housing easily.

A label roll core holding mechanism of a typical label affixing machine is required to support the label roll and its core and to facilitate label roll mounting and removal operations. A holder type core holding mechanism is known as a mechanism for supporting the label roll securely. In this holder type core holding mechanism, a label core support shaft for supporting the label roll core is provided on the main body housing side of the label affixing machine, and a holding plate is provided on a free end side of the label core support shaft so as to be capable of supporting the side face of the label roll and opening and closing about a predetermined shaft of the label affixing machine main body. With this mechanism, a space corresponding to the wound diameter of the label roll must be secured within the label affixing machine main body housing in order to mount the label roll. However, when the label roll is mounted on the label core support shaft provided in the main body housing of the label affixing machine, the label roll is disposed within the main body housing, and hence it is difficult to feed the continuous label strip from the label roll within the narrow main body housing and insert the continuous label strip into the main body housing of the label affixing machine. Moreover, the label roll is mounted in the main body housing of the label affixing machine from a transverse direction, and hence when an in-use label roll is to be exchanged for a label roll having a different shape or the like and the holding plate supporting the side face of the label roll is opened and closed about the predetermined shaft of the label affixing machine, the label roll may fall from the label core support shaft which supports the label roll.

Furthermore, since the label roll takes a roll shape, its edges may become frayed. During the operation to insert the continuous label strip fed from the label roll into the main body housing of the label affixing machine, the continuous label strip is fed and inserted while holding the label roll by hand, and hence the label roll may fall out of the hand or its edges may become frayed.

Also, since the label roll is mounted from the transverse direction of the label affixing machine main body housing, the label core support shaft cannot be provided on a predetermined trajectory of an operating lever, which is supported rockably on the main body housing side of the label affixing machine, and a printing portion which is supported on one end of the operating lever and performs a reciprocating motion as the operating lever rocks, and hence a space for mounting the label roll cannot be secured on the predetermined trajectory of the reciprocating motion of the printing portion in the main body housing. In other words, to allow the operating lever to rock within the main body housing, the label roll must be mounted on the label core support shaft in a position which does not interfere with the operating lever, i.e. a space must be provided for disposing the label core support shaft outside of the trajectory range of the operating lever, and hence the label affixing machine must be increased in size.

As disclosed in Japanese Unexamined Patent Application 2000-281262, a core holding mechanism which focuses on spring bias is known as a core holding mechanism for supporting and holding a label roll with precision.

Japanese Unexamined Patent Application 2000-281262 discloses a core holding mechanism comprising a pair of left and right spring plates provided so as to face each other across a label holding space formed between a pair of left and right side plates, and a pair of left and right core holding lug members provided at the tip end portions of the spring plates for holding the label roll. The core holding lug members each have a rotation shaft portion, a core holding portion for holding the label roll, which is located further toward the label holding space side than the rotation shaft portion, and a lug portion that is located on the opposite side of the rotation shaft portion to the core holding portion and protrudes outward from the side plates. This constitution comprises the pair of left and right spring plates and the pair of left and right core holding lug members which are biased elastically by the spring plates, and hence by forcibly pushing the label roll between the pair of left and right core holding lug members when mounting the label roll, the label roll can be inserted between the core holding lug members against the biasing force of the spring plates. The label roll is pushed until the core holding portion is positioned in the central space portion of the label roll core, and at this point, the core holding lug members are returned to their original positions (core holding attitudes) by the biasing force of the spring plates such that the label roll can be held securely. When the label roll is used up or the label roll is to be changed before being completely used, the lug portions of the core holding lug members are manipulated so as to rotate and tilt as a whole, thereby forming a gap through which the label roll core can be extracted. Thus the core can be removed easily.

Japanese Unexamined Patent Application 2000-281028 discloses a constitution for preventing a label roll mounted in a label affixing machine from becoming dirty such that the affixing characteristic and printing characteristic are adversely affected. A cover main body is provided openably on a side plate of the label affixing machine so as to capable of protecting against dust and dirt, and a hook portion of the cover main body is capable of engaging with a hook engagement portion on the side plate. When the cover main body is closed, a locking protrusion on the inner peripheral side thereof locks a label roll core holding device in a core holding attitude, thereby preventing unintentional removal of the label roll from the core holding device. In the constitutions disclosed in both Japanese Unexamined Patent Application 2000-281262 and Japanese Unexamined Patent Application 2000-281028, the core holding member which holds the label roll core is rotational, and therefore the label roll can be mounted easily. However, it is difficult to feed the continuous label strip from the label roll and insert the continuous label strip into the main body housing of the label affixing machine when the label roll is mounted in the label holding space provided between the side plates of the label affixing machine, and therefore the continuous label strip must be inserted into the main body housing of the label affixing machine before mounting the label roll in the label holding space. During this insertion operation, the label roll is held by hand, and therefore the label roll may be dropped or the edges of the label roll may become frayed.

Further, in Japanese Examined Patent Application H1-56976 and Japanese Unexamined Patent Application 2000-281262, a fixing shaft portion provided on the spring plates within the main body housing of the label affixing machine is fixed to the side plates of the label affixing machine so as to form a label holding space having a predetermined width large enough to allow insertion of the label roll between the left and right side plates, and the spring plates are provided parallel to the side plates. As a result, the spring plates cannot be provided on the predetermined trajectory of the operating lever, which is supported rockably on the main body housing side of the label affixing machine, and a printing portion which is supported on one end of the operating lever and performs a reciprocating motion as the operating lever rocks, and hence a holding space for mounting the label roll cannot be secured on the predetermined trajectory of the reciprocating motion of the printing portion in the main body housing. This results in an increase in the size of the label affixing machine itself. Moreover, components such as an auxiliary spring constituted by a coil spring for exhibiting, together with the spring plates, a biasing force in the direction of the holding space for holding the label roll must be provided on the spring plates in the vicinity of the core holding lug members. As a result, the number of components increases, and component management and so on become difficult.

### SUMMARY OF THE INVENTION

The present invention has been designed in consideration of problems such as those described above, and it is an object thereof to provide a label affixing machine having a core holding mechanism in which the core holding mechanism is provided in a label-protecting cover body provided openably about a main body housing of the label affixing machine, and by rotating the label-protecting cover body, a label roll held by the core holding mechanism can be accommodated in the main body housing of the label affixing machine, thus enabling reductions in both the size and weight of the label affixing machine.

Another object of the present invention is to provide a label affixing machine having a core holding mechanism in which a continuous label strip can be fed from the label roll and inserted into the main body housing of the label affixing machine easily while the label roll is held by the core holding mechanism.

A further object of the present invention is to provide a label affixing machine having a core holding mechanism in which the label roll can be held without falling during an operation to mount or exchange the label roll.

A further object of the present invention is to provide a label affixing machine having a core holding mechanism in which the constitution of the core holding mechanism provided in the main body housing of the label affixing machine is simplified, enabling a reduction in the number of components and a consequent reduction in cost.

The present invention provides a label affixing machine having a label roll core holding mechanism, and focuses on the provision of a core holding mechanism which is capable of feeding a continuous label strip while a label roll is held in the label affixing machine, or more specifically the provision of a core holding mechanism which is capable of holding a label roll in a label-protecting cover body of the label affixing machine. The label affixing machine of the present invention comprises a main body housing formed by a left and right pair of side plates, a label roll conveyance path formed in the main body housing, and a continuous label strip which is fed from a label roll. The continuous label strip is fed onto the conveyance path in strip form, and then the continuous label strip, having a plurality of labels temporarily adhered to a strip-form backing sheet, is conveyed through the interior of the main body housing, where the labels are peeled from the backing sheet so that the labels can be affixed to an article. The label affixing machine further comprises a label-protecting cover body provided openably in the main body housing, and a label core support shaft which is capable of emerging from and descending into the main body housing in accordance with opening and closing operations of the label-protecting cover body, and also capable of supporting an end face of the label roll. A label holding space in which the label roll can be accommodated is provided within the main body housing.

The label affixing machine having a label roll core holding mechanism according to the present invention further comprises the aforementioned label holding space, which is provided between the pair of left and right side plates, a yoke portion forming the label holding space and having two prongs which oppose each other across the label holding space, and a label core support shaft which can be disposed in a position in the vicinity of the two-pronged yoke portion.

Further, the label affixing machine having a label roll core holding mechanism according to the present invention comprises a main body housing formed by a left and right pair of side plates, a label roll conveyance path formed in the main body housing, and a continuous label strip which is fed from the label roll. The continuous label strip is fed onto the conveyance path in strip form, and then the continuous label strip, having a plurality of labels temporarily adhered to a strip-form backing sheet, is conveyed through the interior of the main body housing, where the labels are peeled from the backing sheet so that the labels can be affixed to an article. The label affixing machine further comprises a label-protecting cover body provided openably in the main body housing, and a label core support shaft which is capable of emerging from and descending into the main body housing in accordance with opening and closing operations of the label-protecting cover body, and also capable of supporting an end face of the label roll. The label core support shaft is capable of holding the label roll in the label-protecting cover body, and comprises a fall preventing member which is capable of sliding in accordance with the opening and closing operations of the label-protecting cover body.

Further, the label core support shaft according to the present invention comprises an open end face provided on one end thereof, a bore hole reception portion provided on the open end face for holding the fall preventing member, a wall surface for guiding the fall preventing member slidably, and a guiding groove for guiding the fall preventing member in a predetermined direction.

Further, the fall preventing member according to the present invention comprises a guiding long hole provided in the fall preventing member, and a sliding skirt portion provided on one surface of the fall preventing member. The fall preventing member is also provided with a brim portion formed on the inner periphery of the guiding long hole, which engages slidably with an attachment member that can be inserted into the guiding long hole and holds the fall preventing member slidably on the label core support shaft.

In the label affixing machine comprising a core holding mechanism for holding a label roll according to the present invention, the label core support shaft for holding a label roll R is provided in the label-protecting cover body, and therefore the label roll is capable of emerging from and descending into the main body housing in accordance with the opening and closing operations of the label-protecting cover body. As a result, the label roll can be changed easily, and moreover the label roll can be accommodated within the main body housing, enabling a reduction in size and enhanced compactness in the label affixing machine itself.

Further, in the label affixing machine comprising a core holding mechanism for holding a label roll according to the second invention, the fall preventing member, which is capable of supporting the end face of the label roll, is attached slidably to the label core support shaft provided in the label-protecting cover body, which is provided openably in the main body housing, and hence the label roll can be prevented from falling during operations to mount and change the label roll. The label roll can also be prevented from falling during insertion of the continuous label strip into the main body housing while the label roll is held on the label core support shaft of the label-protecting cover body, and since the continuous label strip can be fed while held in the label-protecting cover body, the operation to insert the continuous label strip into the main body housing can be performed easily.

The open end face provided on one end of the label core support shaft according to the present invention comprises the wall surface and the guiding groove, and hence when the label-protecting cover body is open, the sliding skirt portion of the fall preventing member can only be guided in a fixed direction. Hence, free movement such as rotation of the fall preventing member can be restricted during an operation to close the label-protecting cover body, whereby the label-protecting cover body opening and closing operations can be performed smoothly and the label roll can be mounted with precision.

Further, the guiding hole provided in the fall preventing member according to the present invention is provided with the brim which protrudes in the inner peripheral direction of the guiding hole. Hence, the attachment member which holds the fall preventing member on the label core support shaft can be fastened loosely, enabling the fall preventing member to slide smoothly.

### BRIEF DESCRIPTION OF THE DRAWINGS

FIG. 1 is a schematic sectional view of a label affixing machine 1 with a label-protecting cover body in an open state;

FIG. 2 is a schematic sectional view of the label affixing machine 1 with the label-protecting cover body in a closed state;

FIG. 3 is a sectional view along a line III-III of FIG. 2;

FIG. 4 is an exploded perspective view showing the peripheral constitution of a core holding mechanism 4;

FIG. 5A is an enlarged view of the main parts of the core holding mechanism 4 part with the label-protecting cover body 20 in a closed state; and

FIG. 5B is an enlarged view of the main parts of the core holding mechanism 4 part with the label-protecting cover body 20 in an open state.

### DESCRIPTION OF THE PREFERRED EMBODIMENTS

The present invention employs a constitution in which a label roll can be held in a label-protecting cover body which is attached to be openable about a predetermined shaft of a main body housing of a label affixing machine. As a result, a compact, reasonably-priced label affixing machine can be realized, and a label affixing machine having a core holding mechanism in which a label roll can be mounted easily is provided.

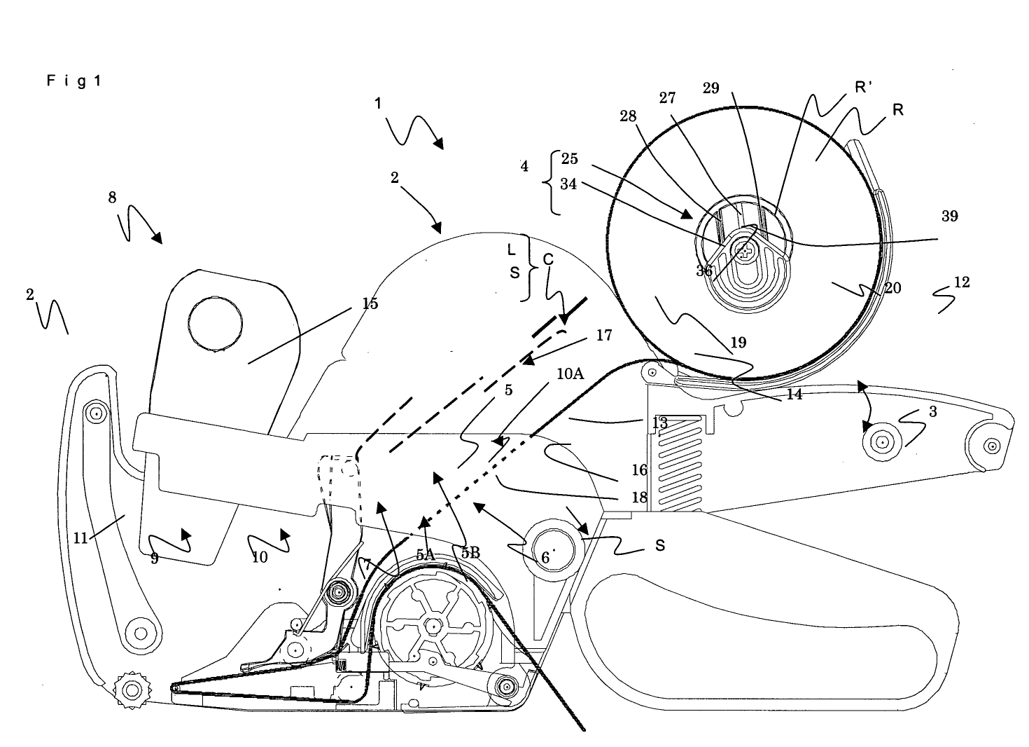

A label affixing machine having a core holding mechanism according to an embodiment of the present invention will now be described on the basis of FIGS. 1 through 5.

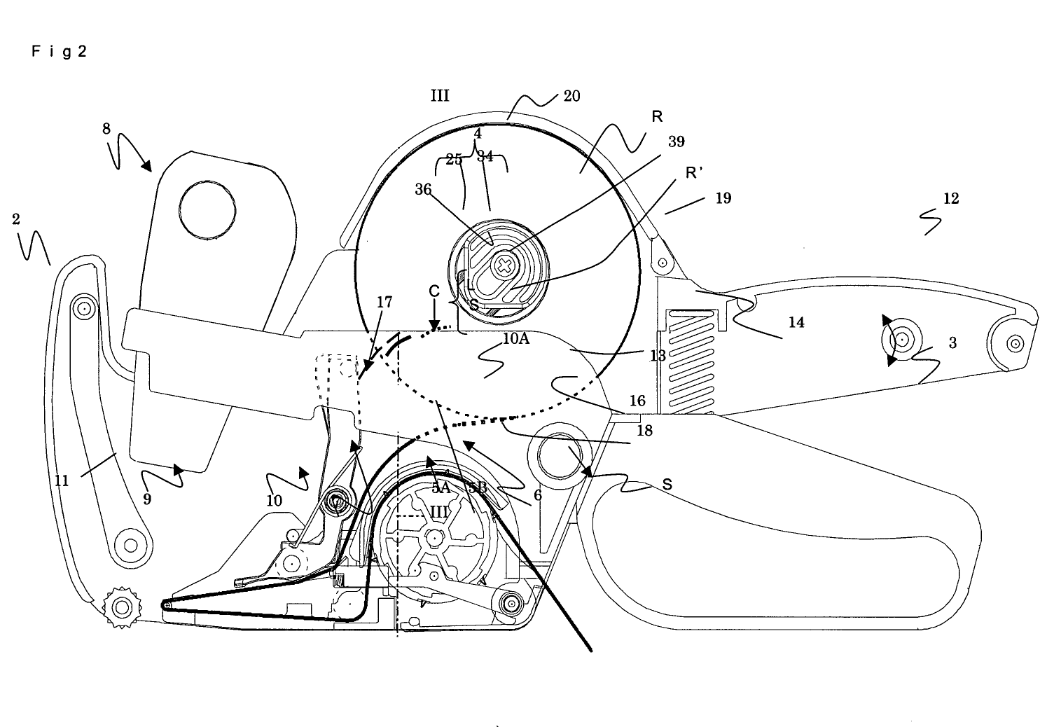

FIG. 1 is a schematic sectional view of a label affixing machine 1 with a label-protecting cover body in an open state, and FIG. 2 is a schematic sectional view of the label affixing machine 1 with the label-protecting cover body in a closed state. The label affixing machine 1 comprises a main body housing 2, an operating lever 3, a core holding mechanism 4, a conveyance wheel 5, a driving mechanism 6 having a stopper, a label stopper mechanism 7, a printing mechanism 8 (print stamping mechanism), a peeling mechanism 9, a label guiding mechanism 10, an affixing roller 11, and a label-protecting cover body 20.

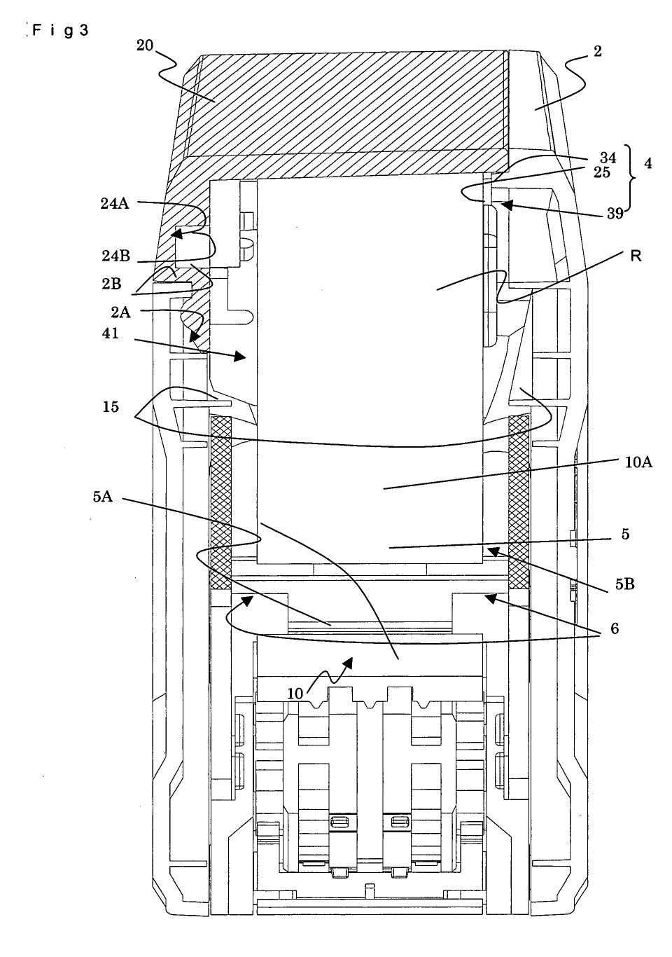

As shown in FIGS. 1 and 2, the main body housing 2 of the label affixing machine 1 is constituted by a pair of left and right (see FIG. 3) side plates accommodating the entire label affixing machine 1, while a grip 12 is formed on the upper rear portion (the upper right of the drawing) of the main body housing 2.

The operating lever 3 is mounted rotatably about an operating lever shaft 13, and can be manipulated in relation to the main body housing 2 (grip 12). A compression spring 14 is interposed between the operating lever 3 and grip 12 such that the operating lever 3 can be gripped together with the grip 12 against the biasing force of the compression spring 14, and released. Note that the operating lever 3 comprises an arm connecting portion 16 which extends to the rear (the left side of the drawing) of the conveyance wheel 5 and a yoke portion 15 having two connected prongs which extend in the direction of the printing mechanism 8.

A continuous label strip C is provided with a plurality of labels L temporarily adhered to a strip-form backing sheet S. The continuous label strip C is mounted in the label-protecting cover body 20 of the core holding mechanism 4, to be described below, as a label roll R wound into roll form, and fed onto a conveyance path 17 within the main body housing 2 through an insertion opening portion (not shown) in the main body housing 2.

The core holding mechanism 4 is constituted by a label core support shaft 25, which is attached to the label-protecting cover body 20 and supports the core of the label roll R, and a slidable fall preventing member, which is attached to the label core support shaft 25 to be capable of supporting the side face of the label roll R. The outer diameter of the label core support shaft 25 is slightly smaller than the inner diameter dimension of a core R′ of the label roll R. As shown in FIG. 2 in particular, the label core support shaft 25 may be disposed in the vicinity of the two-pronged yoke portion 15 in the main body housing 2.

The conveyance path 17 extends from the core holding mechanism 4 past the label stopper mechanism 7 and printing mechanism 8 parts. At the peeling mechanism 9, the backing sheet S alone is turned back so as to engage with the conveyance wheel 5, whereupon the backing sheet S is discharged to the exterior of the main body housing 2 between the arm connecting portion 16 and a discharge guiding portion 18 to be described below.

The conveyance wheel 5 is supported rotatably about a rotary shaft 5B shown in the drawing, and an arc-shaped backing sheet guide cover 10A is mounted above the conveyance wheel 5 so as to cover the conveyance wheel 5. Thus the backing sheet S is able to pass between the backing sheet guide cover 10A and the conveyance wheel 5. The conveyance wheel 5 is capable of engaging with the backing sheet S by means of engaging claws 5A formed on the peripheral surface thereof at equiangular intervals corresponding to the pitch of the labels L. Therefore, when the operating lever 3 is gripped and released such that the conveyance wheel 5 rotates, the backing sheet S, or in other words the continuous label strip C, can be conveyed in a downstream direction.

When the operating lever 3 is gripped, printing is performed on the continuous label strip C (label L) by the printing mechanism 8, and when the operating lever 3 is released, the continuous label strip C is conveyed in the downstream direction and the label L is peeled away from the backing sheet S by the peeling mechanism 9. Then, with the grip 12 and operating lever 3 in a released state, the entire label affixing machine 1 is brought into contact with a desired article (not shown) so that the label L can be affixed thereto by the affixing roller 11.

FIG. 3 is a sectional view along a line III-III of FIG. 2, and shows a state in which the label-protecting cover body is closed.

As shown in FIG. 3, the interior of the main body housing 2 of the label affixing machine 1 is hollow, and the two-pronged yoke portion 15 is disposed along inner walls 2A of the main body housing 2. A label holding space 41 having a predetermined width large enough to enable insertion of the label roll R is provided in the two-pronged yoke portion 15. Furthermore, as shown in FIG. 1 or FIG. 2, the two-pronged yoke portion 15 is capable of rocking about a spindle of the operating lever shaft 13, and extends in the direction of the printing mechanism 8.

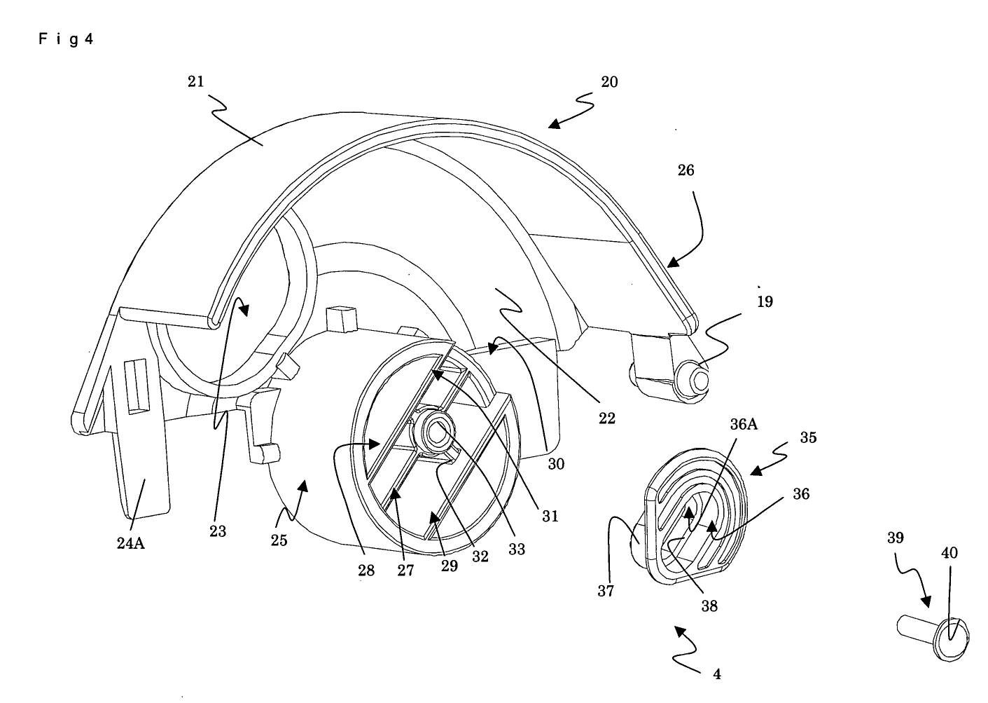

FIG. 4 is an exploded perspective view showing the peripheral constitution of the core holding mechanism 4. As shown in FIG. 4, the core holding mechanism 4 is constituted by the label core support shaft 25, which is provided in the label-protecting cover body 20 for covering the mounted label roll R, and [the slidable fall preventing member 34, which] is capable of supporting the side face of the label roll R.

As shown in FIG. 4, the label-protecting cover body 20 comprises an arc-shaped part 21 which covers a space for holding the label roll R from above, and a semicircular side wall 22 formed along one edge of the arc-shaped part 21. Note that the other edge of the arc-shaped part 21 is left open so that the label roll R can be mounted.

An opening/closing window 23 is provided in the semicircular side wall 22 for checking the wound diameter of the label roll R and for opening and closing the label-protecting cover body 20 by hooking the label-protecting cover body 20 with a finger, as will be described below. Further, the label core support shaft 25 is provided on the side wall 22 so as to extend parallel to the arc-shaped part of the label-protecting cover body 20.

The label-protecting cover body 20 comprises an opening/closing shaft portion 19 formed on one end of the arc-shaped part 21 to be capable of opening and closing the label-protecting cover body 20, and a hook portion 24A formed on the opposite end side to the opening/closing shaft portion 19 so as to protrude toward the interior of the main body housing 2 of the label affixing machine 1 from the semicircular side wall 22. As shown in FIG. 3 in particular, the hook portion 24A can be engaged with a hook engagement portion 24B provided on one of the side plates in the main body housing 2 of the label affixing machine 1, and by engaging the hook portion 24A with the hook engagement portion 24B, the label-protecting cover body 20 can be closed securely. Note that the opening/closing shaft portion 19 is capable of rotating the label-protecting cover body 20 in an opening/closing direction when engaged with a shaft support hole portion (not shown)formed in the main body housing 2 of the label affixing machine 1.

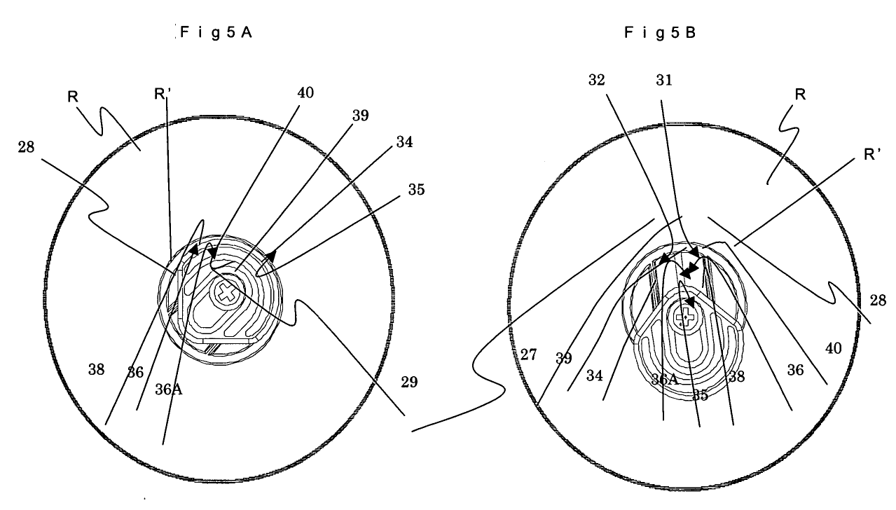

FIG. 5A is an enlarged view of the main parts of the core holding mechanism 4 part with the label-protecting cover body 20, mounted with the label roll R, in a closed state, and FIG. 5B is an enlarged view of the main parts of the core holding mechanism 4 part with the label-protecting cover body 20 in an open state.

The core holding mechanism 4 is constituted by the label core support shaft 25 which can be attached to the label-protecting cover body 20 for supporting the core of the label roll R, and the slidable fall preventing member which is attached to the label core support shaft 25 to be able to support the side face of the label roll R.

The label core support shaft 25 takes a hollow cylindrical form, extends from the side wall 22, and comprises an open end face having a circular cross section at one end, and a fall preventing member 34 attached slidably to the open end face 26. The fall preventing member 34 takes a panel or disk shape, for example, and comprises a guiding long hole 36 and an upright sliding skirt portion 37 which is provided on at least one surface of the fall preventing member 34 around the guiding long hole 36.

A first rib 27 having a length that is equal to the inner diameter of the circular cross-section open end face 26 is disposed across the axial direction of the label core support shaft 25, while a second rib 28 and a third rib 29 are provided on either side of and parallel to the first rib 27. Further, a guiding groove portion 30 for guiding the fall preventing member 34 in a manner to be described below is provided in the outer peripheral edge of the circular cross-section open end face 26 from the second rib 28 to the third rib 29. The guiding groove portion 30 is positioned in the direction of the arc-shaped part 21 of the label-protecting cover body 20.

As shown in FIG. 4 in particular, the second and third ribs 28, 29 protrude beyond the end portion of the first rib 27, which is exposed to the open end face 26 side, and comprise respective wall surfaces 31, 32 which oppose each other. A bore hole reception portion 33 is disposed in the space surrounded by the wall surface 31 and the wall surface 32 in a substantially central position of the circular cross-section open end face 26 so as to protrude beyond the end portion of the first rib 27. The bore hole reception portion 33 is inserted into the guiding long hole 36 of the fall preventing member 34 from the sliding skirt portion 37 side. Note that the guiding long hole 36 is formed with a brim portion 38 which protrudes inward from the inner periphery of the guiding long hole 36. As shown in the drawing, the inner diameter of the guiding long hole 36 from the brim portion 38 of the guiding long hole in the standing direction of the sliding skirt portion 37 is smaller than the inner diameter of the guiding long hole 36 on the attachment direction side of an attachment member 39 to be described below, and hence a guiding long hole 36A having a small inner diameter is formed in the sliding skirt portion.

The fall preventing member 34 has a substantially fan-shaped cross section and comprises an arc-shaped portion 35 which matches the outer peripheral arc line of the open end face 26 of the label core support shaft 25.

The sliding skirt portion 37 of the fall preventing member 34 is accommodated slidably between the wall surfaces 31 and 32 which form the space in the open end face 26, and the fall preventing member 34 is attached movably to the open end face 26 of the label core support shaft 25 by an attachment member 39 such as an attachment pin or bolt which is inserted into the bore hole reception portion 33 positioned so as to be capable of engaging with the small-diameter guiding long hold 36A. In other words, the attachment pin or bolt is provided with a flange portion 40. The attachment member 39 is inserted into the bore hole reception portion 33 so as to provide play allowing the flange portion 40 to slide along the brim portion 38 on the inner periphery of the guiding long hole 36, and thus the fall preventing member 34* is fitted loosely and slidably onto the label core support shaft 25.

By fitting the attachment member 39 into the bore hole reception portion 33, which is positioned in the small-diameter guiding long hole 36A of the fall preventing member 34, and engaging the flange portion 40 of the attachment member slidably with the brim portion 38 of the guiding long hole 36, the fall preventing member 34 is held on the open end face 26 of the label core support shaft 25 so as to be capable of smooth movement. Thus the fall preventing member 34 can move in the radial direction of the open end face 26 of the label core support shaft 25 about the bore hole reception portion 33.

Next, an operation of the label-protecting cover body 20 and operations to mount the label roll R in the core holding mechanism 4 and remove the core of the label roll R therefrom will be described in relation to the core holding mechanism 4 of the label affixing machine 1 constituted in the manner described above.

As shown in FIG. 5A, during normal use of the label affixing machine 1, the fall preventing member 34 is held within the inner diameter of the label core support shaft 25 such that the arc-shaped portion 35 of the fall preventing member 34 is disposed in alignment with the outer peripheral edge of the open end face 26. When the fall preventing member 34 shifts, as shown in FIG. 5B, the arc-shaped portion 35 protrudes from the outer peripheral edge of the label core support shaft 25 so as to hang from the bore hole reception portion 33 in an outward radial direction.

More specifically, as shown in FIGS. 1 and 2, the label-protecting cover body 20 is hinged to the main body housing 2 so that it can be opened and closed along a predetermined trajectory, and thus the label roll R can be changed easily.

When the label-protecting cover body 20 rotates in relation to the main body housing 2, the label core support shaft 25 moves in conjunction therewith, and thus the open end face 26 of the label core support shaft 25 can emerge from and descend into the main body housing 2 of the label affixing machine 1. More specifically, by pulling the label-protecting cover body 20 upward through the opening/closing window 23, the engagement between the hook portion 24A and hook engagement portion 24B can be released and the label-protecting cover body 20 can be opened.

As shown in FIG. 1, when the label-protecting cover body 20 is opened, the open end face 26 of the label core support shaft 25 protrudes from the main body housing 2. At this time, the wall surfaces 31, 32 provided in the open end face 26 are positioned substantially perpendicular to the grip 12. To attach the label roll R from the direction of the open end face 26 of the label core support shaft 25, the fall preventing member 34 is lifted up, the label core support shaft 25 is inserted into the core of the label roll R, and then the fall preventing member 34 is allowed to hang under its own weight.

In other words, the fall preventing member 34 attached to the open end face 26 is guided along the wall surfaces 31, 32 which face the sliding skirt portion 37, and drops down through the guiding groove portion 30 in the gravitational direction, i.e. the downward direction of the drawing. When the fall preventing member 34 drops, the bore hole reception portion 33 and attachment member 39 holding the fall preventing member 34 on the open end face 26 shift from one end to the other end of the guiding long hole 36 such that the arc-shaped portion 35 of the fall preventing member 34 protrudes from the outer peripheral edge of the label core support shaft 25.

Certainly, the arc-shaped portion 35 of the fall preventing member 34 protrudes from the outer peripheral edge of the label core support shaft 25 and guides the end face of the label roll R, and hence the continuous label strip C is fed from the label roll R mounted on the label core support shaft 25 onto the conveyance path 17 in the main body housing 2 of the label affixing machine 1 while the label roll R is held on the label core support shaft 25. Hence, during the following series of operations for inserting the continuous label strip C, in which the continuous label strip C passes the printing mechanism 8 in the main body housing 2, the backing sheet S alone is turned back by the peeling mechanism 9 so as to engage with the conveyance wheel 5, and the backing sheet S is discharged to the exterior of the main body housing 2 of the label affixing machine 1 between the arm connecting portion 16 and the discharge guiding portion 18, the label roll R can be preventing from falling off the label core support shaft 25. Moreover, this operation for inserting the continuous label strip C that is fed from the label roll R can be performed easily while the label roll R is supported by the label core support shaft 25.

As shown in FIG. 2, when the label-protecting cover body 20 is closed, the open end face 26 of the label core support shaft 25 is hidden in the interior of the main body housing 2 of the label affixing machine 1, and the fall preventing member 34 is guided along the wall surfaces 31, 32 facing the sliding skirt portion 37 so as to return to a position within the inner diameter of the label core support shaft 25. In other words, the bore hole reception portion 33 and attachment portion 39 which hold the fall preventing member 34 on the open end face 26 shift from the other end of the guiding long hole 36 to their original position at the first end, whereby the arc-shaped portion 35 of the fall preventing member 34 moves back into alignment with the outer peripheral edge of the open end face 26 of the label core support shaft 25.

The sliding skirt portion 37 of the fall preventing member 34 is held guidably along the wall surfaces 31, 32, and hence when the label-protecting cover body 20 is closed, the fall preventing member 34 can be prevented from free movement such as rotation about the bore hole reception portion 33 and attachment portion 39 by which the fall preventing member 34 is supported. As a result, the fall preventing member 34 does not come into contact with components in the interior of the main body housing such as the inner walls 2A, ribs (not shown), and two-pronged yoke portion 15, and the label-protecting cover body 20 can be closed securely. Thus the label roll R attached to the label core support shaft 25 is mounted in the main body housing 2 of the label affixing machine 1 out of the reach of an operator.

In other words, the label roll R can be housed within the main body housing 2 of the label affixing machine 1 in the label holding space 41 of the two-pronged yoke portion 15 which performs a reciprocating motion when the rockably supported operating lever is rocked.

As shown in FIG. 3 in particular, when the label roll R is mounted in the main body housing 2 and the operating lever 3 is released (i.e. the operating lever 3 is not gripped), the two-pronged yoke portion 15 and the label core support shaft 25 supporting the label roll R are disposed close together. The label holding space 41, having a width enabling the label roll R to be sandwiched from both sides, is provided in the two-pronged yoke portion 15, and therefore the label roll R is disposed within the label holding space 41 of the two-pronged yoke portion 15.

Hence, the label roll R can be accommodated within the main body housing 2 of the label affixing machine 1, and therefore the label affixing machine 1 itself can be made compact.

Furthermore, since the label holding space 41, having a width enabling the label roll R to be sandwiched from both sides, is provided in the two-pronged yoke portion 15,the continuous label strip C which is fed from the label roll R can be guided with appropriate width restrictions in the width direction thereof by gripping the operating lever 3 in relation to the grip 12 such that the two-pronged yoke portion 15 descends in the conveyance path direction using the operating lever shaft 13 as a pivot.

Note that the above embodiment was described on the basis of a label affixing machine, but the present invention is not limited to a label affixing machine, and may also be applied to a printer having a label core support shaft.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A label affixing machine having
a label roll core holding mechanism, operable to hold a continuous label strip forming a label roll and having a plurality of labels temporarily adhered to a strip-form backing sheet
a main body housing having an interior and wherein the backing sheet is conveyed through the interior of the main body housing where labels are peeled from the backing sheet so that the labels can be affixed to an article,
the machine comprising:
said main body housing;
an operating lever provided rockably in said main body housing, said lever having a label holding space in which said label roll can be accommodated in said main body housing; and
a label-protecting cover having a label core support shaft for supporting said label roll and provided openably in said main body housing,
wherein said label roll can be positioned in said label holding space when said label-protecting cover is closed, and said label roll can be disposed in a position outward of said main body housing when said label-protecting cover is open.

2. The label affixing machine having a label roll core holding mechanism according to claim 1, further comprising a yoke connected to said operating lever the yoke having two prongs which oppose each other across said label holding space,
wherein said label core support shaft is movable by said lever into a position in the vicinity of said two-pronged yoke.

3. A label affixing machine having a label roll core holding mechanism, in which a continuous label strip forming a label roll and having a plurality of labels temporarily adhered to a strip-form backing sheet is conveyed through the interior of a main body housing where said labels are peeled from said backing sheet so that said labels can be affixed to an article, comprising:
said main body housing;
a label-protecting cover provided openably in said main body housing; and
a label core support shaft which is capable of emerging from and descending into said main body housing in accordance with opening and closing operations of said label-protecting cover, and of supporting said label roll,
wherein said label core support shaft is capable of holding said label roll within said label-protecting cover body, and
a fall preventing member which slides with respect to said shaft in accordance with said opening and closing operations of said label-protecting cover body, and said member is operable selectively to support an end face of said label roll.

4. The label affixing machine having a label roll core holding mechanism according to claim 3, wherein said label core support shaft comprises an open end face provided on one end thereof, a bore hole reception portion provided on said open end face for holding said fall preventing member, a wall surface for guiding said fall preventing member slidably, and a guiding groove for guiding said fall preventing member to slide in a predetermined path between the slid position.

5. The label affixing machine having a label roll core holding mechanism according to claim 4, wherein said fall preventing member comprises a guiding long hole provided in said fall preventing member, a sliding skirt portion provided on one surface of said fall preventing member, and a brim portion provided on an inner periphery of said guiding long hole for holding said fall preventing member slidably on said label core support shaft.

6. The label affixing machine having a label roll core holding mechanism according to claim 3, further comprising apparatus for feeding the backing sheet through the housing and for peeling the labels from the backing sheet.

7. The label affixing machine having a label roll core holding mechanism according to claim 1, further comprising apparatus for feeding the backing sheet through the housing and for peeling the labels from the backing sheet.

8. A method for loading a label roll in a label roll core holding mechanism, wherein the holding mechanism comprises an operating lever rockable with respect to a main body,
the main body having a housing having an interior in which the label roll is to be disposed during feeding of a label strip on the label roll;
a label roll support including a label roll core holder supported to the housing; a label core fall preventing member at the support;
the method comprising:
positioning the support outside the housing interior to expose the core holder to enable mounting a roll core thereon,
positioning the fall preventing member at the support in a passing condition at which the roll core may pass over the fall preventing member and onto the core holder; and
then positioning the support with the label roll thereon inside the housing interior.

9. The method for loading a label roll of claim 8, further comprising:
repositioning the fall preventing member with respect to the core holder to a blocking position at which the fall preventing member blocks the core holder from passing the fall preventing member to move off the core holder; and
then positioning the support with the label roll thereon inside the housing inside the housing interior.

10. The method for loading a label roll of claim 9, wherein when the support is inside the housing interior, repositioning the fall preventing member to the passing condition so that the core holder could pass the fall preventing member.

11. The method for loading a label roll of claim 10, further comprising orienting and supporting the fall preventing member at the core holder such that when the support is outside the housing interior, the fall preventing member shifts to the blocking position, and when the support is inside the housing interior, the fall preventing member shifts to the passing condition.

12. The method for loading a label roll of claim 11, wherein the fall preventing member is oriented and supported so that the shifting thereof to the blocking position outside the housing interior and to the passing condition inside the housing interior is caused by gravity acting on the fall preventing member and the fall preventing member is raised to the passing condition when the support is outside the housing interior.

13. The method for loading a label roll of claim 12, wherein the support is pivoted with respect to the housing between outside and inside the interior of the housing, for swinging the holder inside and outside the housing interior.

14. The method for loading a label roll of claim 11, wherein the support is pivoted with respect to the housing between outside and inside the interior of the housing, for swinging the holder inside and outside the housing interior.
